(19) United States
(12) Patent Application Publication
(10) Pub. No.: US 2007/0193442 A1
(43) Pub. Date: Aug. 23, 2007

(54) Variable Mode Manipulator and Drive System

(76) Inventor: Richard W. McCoy JR., Cypress, TX (US)

Correspondence Address: DUANE MORRIS LLP, 3200 SOUTHWEST FREEWAY, SUITE 3150, HOUSTON, TX, 77027, US

(21) Appl. No.: 11/675,673

(22) Filed: Feb. 16, 2007

Related U.S. Application Data
(60) Provisional application No. 60/774,569, filed on Feb. 17, 2006.

(51) Int. Cl. F15B 13/044

(52) U.S. Cl. 91/459

(57) ABSTRACT

The invention relates to a manipulator arm drive system that can be operated in variable rate modes. The variable mode manipulator arm drive system of the invention can be operated in a variable rate mode, a proportional rate mode, and a force feedback mode. It can also be hydraulically operated subsea.

### CROSS REFERENCE TO RELATED APPLICATION

This application claims the benefit of Provisional Application 60/774,569, filed Feb. 17, 2006.

### BACKGROUND OF THE INVENTION

1. Field of the Invention

The invention relates to a manipulator arm drive system that can be operated in several rate modes. The variable mode manipulator arm drive system of the invention can be operated in a variable rate mode, a proportional rate mode, and a force feedback mode. It can also be hydraulically operated subsea.

2. Description of the Prior Art

Prior art manipulator arms are operable in two primary modes, rate mode and spatially correspondent (“SC”) mode. In rate mode, each of the manipulator degrees-of-freedom (DOF) is controlled by an actuator which in turn is controlled via a directional control valve that is either fully on or fully off. While the term “rate mode” is familiar to those skilled in the manipulator arm art, it does not provide a literal description of the functional capabilities of this mode. In prior art rate mode, the manipulator joint is either moving at full speed or it is completely stopped. In prior art rate mode, the rate of movement or velocity of the manipulator arm is not controlled.

A rate mode manipulator arm and drive system suitable for subsea applications is shown in FIG. 1. In rate mode, the operator energizes a directional control valve by depressing individual buttons or button in order to move the directional control valve, and hence the actuator, in the desired direction. Rate mode manipulators operate in an “open-loop” fashion wherein the operator depresses the corresponding button or buttons until the manipulator joint or joints move into the desired position. The operator monitors the position of the manipulator visually. In subsea applications using an ROV, this may be accomplished via a subsea camera. There is no position feedback signal utilized in the manipulator control electronics itself.

Prior art rate mode provides a more awkward method of controlling a manipulator arm than SC mode; however, rate mode manipulation is simpler and less costly to implement than SC mode manipulation. A rate mode manipulator is also more reliable than an SC mode manipulator because it requires less electronics than an SC mode manipulator.

In the SC mode (also known as “position controlled mode”), the position of each manipulator arm joint is known and controlled. Typically, an SC manipulator system comprises two parts: a master and a slave. The master is usually a hand controller that is equipped with a number of joints whose angular position is measured and monitored as the operator moves the controller. Generally, the master has a joint arrangement that mimics the joint arrangement of the slave. The slave is the manipulator itself. The slave will move in proportion to the master hand controller. If a joint on the master is moved slowly, the slave joint will move slowly. If the master is moved quickly, the slave will move quickly. An SC mode manipulator arm and drive system is shown in FIG. 2.

Prior art SC manipulators operate in “closed-loop” mode, which uses an error signal that represents the position of each and every joint on the slave. This signal is continuously compared to the desired joint position (as indicated by the position of the master's matching joint) and the direction and magnitude of the corresponding control valve is modulated as necessary according to some sort of algorithm which is usually a variant of a proportional, integral, derivative (PID) loop.

Prior art SC mode manipulator systems have several problems. Each joint of the slave must be equipped with a position feedback device such as an encoder, resolver, or potentiometer. The control algorithm absolutely must have a reliable signal from this device in order for the manipulator to work. If any of the feedback devices fail, then the manipulator is unusable.

The velocity and acceleration of the slave joints must be variable and, preferably, stepless. Traditionally, this has been achieved by using hydraulic servo valves which suffer four disadvantages, which are high cost, propensity for failure due to lack of fluid cleanliness, high leakage rate, and high pressure drop at high flow rates. In order to increase the longevity of the SC manipulator, an isolate hydraulic power unit (HPU) is often required. This adds to the cost, weight and complexity of the system.

SC mode manipulators are easier than rate mode manipulators to operate. They also provide the operator with a fluid touch. An SC mode manipulator requires more responsive valves and electronics than a rate mode manipulator. This results in increased complexity and reduced reliability for an SC mode manipulator versus a rate mode manipulator.

### DESCRIPTION OF THE DRAWINGS

FIG. 1 depicts a rate mode manipulator arm and drive system of the prior art.

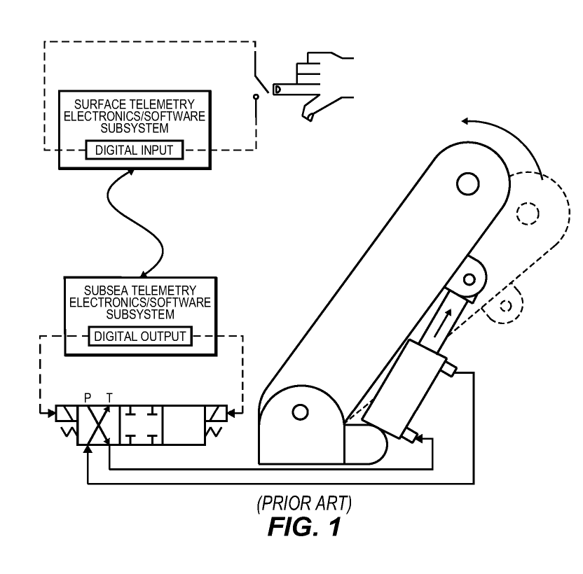

FIG. 2 depicts an SC mode manipulator arm and drive system of the prior art.

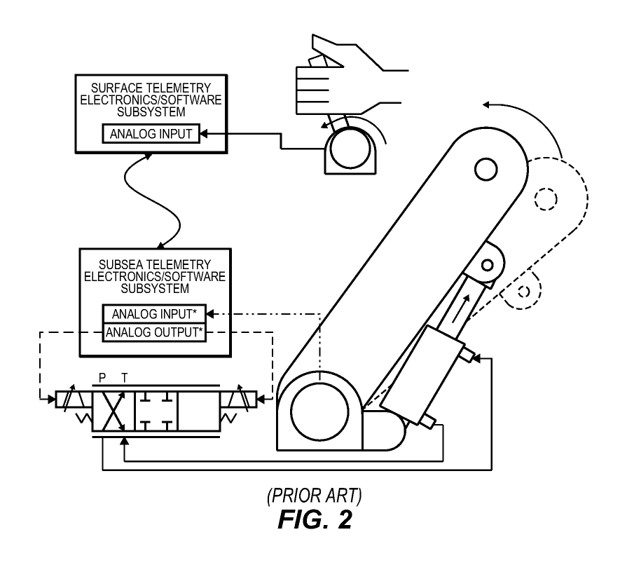

FIG. 3 depicts a system level diagram of a first embodiment of the invention.

FIG. 4 is a block diagram of a second embodiment the invention.

### DETAILED DESCRIPTION OF THE PREFERRED EMBODIMENTS

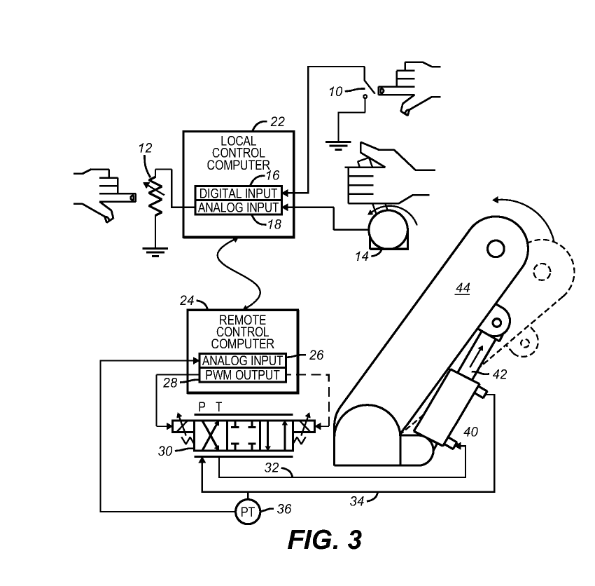

A preferred embodiment of the invention is directed to a variable and adjustable rate controlled drive system for a manipulator. In a preferred embodiment, this system is selectively operable in one of two alternative modes within the rate mode, as shown in FIG. 3. These two modes are the (a) variable rate mode, and (b) proportional rate mode. In another preferred embodiment, this system is selectively operable in a third mode, the force feedback rate mode. The present invention allows for improved controllability and usability of a rate arm without adding the complexity of position feedback electronics usually associated with SC or position-controlled manipulators.

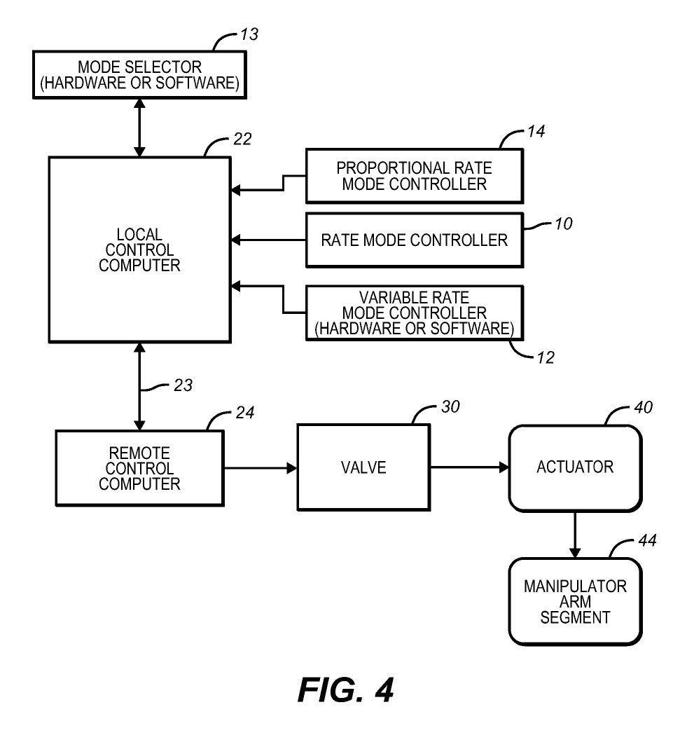

In one preferred embodiment, the invention comprises a proportional mode controller 14 configured to output a proportional mode control signal responsive to the position of the proportional mode controller, as shown in FIG. 4. In one embodiment, the proportional mode controller is a hand controller.

In this embodiment, the invention further comprises a variable rate mode controller 12 configured to output a variable rate mode control signal responsive to a preselected setting, as shown in FIG. 4. In one embodiment, the variable rate mode controller is a potentiometer.

In this embodiment, the invention further comprises a mode selector device 10 operatively coupled to the local control computer 22 (LCC) so as to cause the LCC to selectively receive at least one of the variable rate mode control signal and the proportional mode control signal and to selectively output one of the variable rate mode control signal and the proportional mode control signal as the selected mode control signal, as shown in FIG. 4. The term “computer” as used herein encompasses a microprocessor. The LCC is operatively coupled to receive a selected input from receive a selected input from the proportional mode controller or from the variable rate mode controller. The mode selector switch selects which input the LCC receives. In one embodiment, the mode selector device is a switch. In another embodiment, the mode selector switch is a button on a graphical user interface screen. In another embodiment, the mode selector switch is contained within the LCC.

In a preferred embodiment, the invention also includes a fourth mode, which is the conventional on or off rate mode. In this fourth mode, the operator actuates a rate controller button 10, as shown in FIG. 3. In a preferred embodiment, the rate controller button is an on/off switch 10.

The variable rate mode allows the flow rate of each of the proportional valves to be preset so that when a rate controller button 10 is depressed, the proportional valve 30 opens to a preset percentage of its full open position. In the preferred embodiment shown in FIG. 3, proportional valve 30 comprises a fluid inlet port and a fluid outlet port, and is configured to receive a current signal from the pulse with modulation (PWM) controller 28 which serves as a control signal. The PWM controller produces a control signal comprising variable current by varying the duty cycle of a square wave output. The amount of current produced is proportional to the on time of the PWM controller relative to the off time. Thus, a longer on time, in proportion to the controller's off time will produce a higher current. The spool of the proportional valve is displaced in proportion to the magnitude of the current produced by the PWM controller. Additionally, hydraulic fluid flow varies in direct proportion to spool displacement. This allows the operator to set the velocity at which each joint will move at when the button is pushed.

The advantage of this mode is that it allows the operator to compensate for variations in hydraulic performance that occur with depth or temperature changes frequently encountered in a subsea environment. It also allows the operator to adjust joint velocity to suit personal preference. This scheme does not require any hardware located at the actuator beyond a Rate hand controller.

In another preferred embodiment, the operator may change the flow settings via software. Such changes would normally be implemented periodically and not during actual manipulator operations.

As shown in FIG. 3, the variable rate mode controller 12 allows the operator to select the maximum output of the control. This embodiment further comprises a local control computer 22 coupled to the variable rate mode controller, as shown in FIG. 3. The variable rate mode controller 12 is operatively connected to an analog input receiver 18 on the local control computer 22 which is capable of transmitting a digital signal to the remote control computer 24. The remote control computer is equipped with one or more analog input channels 26. In another preferred embodiment, the variable rate mode control signal is an analog signal and the local control computer comprises an analog input receiver operatively coupled to receive the analog signal from the variable rate mode controller.

As shown in FIG. 3, the proportional valve is connected to piston housing 40 by hydraulic lines 32 and 34. In the preferred embodiment shown in FIG. 3, outgoing hydraulic line 32 has a first end connected to the fluid outlet port and a second end opposite the first end. As also shown in FIG. 3, incoming hydraulic line has a first end connected to the fluid inlet port and a second end opposite the first end.

Hydraulic fluid ejected from the proportional valve through line 32 can extend piston 42. In this mode, hydraulic fluid is returned from the piston housing to the proportional valve through line 34. Piston 42 attached to manipulator arm 44 such that extension of the piston causes movement of the manipulator arm in a first direction and retraction of the piston causes movement of the manipulator arm in a second direction, opposite to the first direction. The proportional valve alignment can be reversed to reverse the direction of hydraulic fluid flow, such that hydraulic fluid is ejected from the proportional valve through line 34 and returned to the proportional valve through line 32. In this mode of operation, the piston will be retracted. The other degrees-of-freedom on the manipulator arm work in similar fashion.

The proportional rate mode allows the operator to operate the manipulator without position feedback from the joints. In this mode, each of the proportional valve or valves deliver flow in proportion to the force or displacement of the associated analog input device on the proportional mode controller 14. In the preferred embodiment, shown in FIG. 3, the hand proportional mode controller 14 is a hand controller. The local control computer is also operatively coupled to the proportional mode controller. The local control computer comprises analog input 18. The proportional mode controller is operatively coupled operatively coupled to provide an analog input signal to analog input 18. If the analog input device performs localized conversion of the analog phenomenon, such as force or displacement, then the local control computer 22 will interface to the analog input device via a parallel or serial digital input interface. The local control computer 22 is configured to read, filter, and/or scale the input from the hand controller 14 and composes the digital control signal to be transmitted to the remote control computer (RCC) 24. The local control computer may be operatively connected to the remote control computer via one or more wires or optical fiber 23, as shown in FIG. 3.

In a preferred embodiment, the hand controller 14 is a simple game console controller, such as the Sony Play Station 2 is suitable. As the operator displaces the associated control further or harder, the proportional valve opens further and increases the velocity of the joint. In a preferred embodiment, the proportional valve is located subsea.

The force feedback rate mode uses the same controller 14 as that used in the proportional rate mode but with the addition of simplified “force feedback”. In order to implement this mode, each of the hydraulic circuits between the proportional valve and its associated actuator is equipped with a pressure transmitter 36, as shown in FIG. 3. In a preferred embodiment, the pressure sensor is operatively connected to the incoming hydraulic line and capable of sensing the magnitude of pressure in said line and transmitting a pressure signal to the analog input. As the load associated with a particular joint/actuator increases, the pressure in the actuator increases. In a preferred embodiment directed to a manipulator arm located subsea, the pressure sensor transmits a pressure signal via a subsea remote control computer to the local control computer. The magnitude of the pressure signal, and hence the force, is presented to the operator using lights, sound or vibration.

The foregoing disclosure and description of the inventions are illustrative and explanatory. Various changes in the size, shape, and materials, as well as in the details of the illustrative construction and/or a illustrative method may be made without departing from the spirit of the invention.

What is claimed is:

1. A manipulator drive system comprising:
a. a proportional mode controller configured to output a proportional mode control signal responsive to the position of the proportional mode controller;
b. a variable rate mode controller configured to output a variable rate mode control signal responsive to a preselected setting;
c. a local control computer operatively coupled to receive a selected input from one of the proportional mode controller or the variable rate mode controller;
d. a mode selector device operatively coupled to the local control computer to cause the local control computer to selectively receive at least one of the variable rate mode control signal and the proportional mode control signal and to selectively output one of the variable rate mode control signal and the proportional mode control signal as the selected mode control signal.

2. The drive system of claim 1, wherein the proportional mode controller is a hand controller.

3. The drive system of claim 1, wherein the variable rate mode controller is a hand controller.

4. The drive system of claim 1, further comprising a rate controller button operatively connected to the variable rate mode controller.

5. The drive system of claim 5, wherein the local control computer comprises an analog input receiver operatively coupled to selectively receive the proportional mode control signal.

6. The drive system of claim 6, wherein the selected mode control signal is a digital signal.

7. The drive system of claim 6, wherein the local control computer is configured to read, filter and scale the proportional mode signal.

8. The drive system of claim 7, further comprising a remote control computer operatively connected to the local control computer to receive the selected mode control signal, said remote control computer comprising:
a. at least one analog input channel; and
b. a pulse width modulated output unit, capable of generating a control signal.

9. The drive system of claim 8, further comprising:
a. proportional valve comprising a fluid inlet port and a fluid outlet port, said proportional valve being configured to receive the control signal from the pulse width modulated output unit;
b. a outgoing hydraulic line having a first end connected to the fluid outlet port and having a second end opposite the first end;
c. an incoming hydraulic line having a first end connected to the fluid inlet port and having a second end opposite the first end;
d. a piston housing comprising an inlet port connected to the second end of the outgoing hydraulic line and an outlet port connected to the second end of the incoming hydraulic line; and
e. a piston slideably mounted within the piston housing such that it can be selectively retracted or extended in response to the direction of hydraulic fluid flow in the outgoing and incoming hydraulic lines.

10. The drive system of claim 9, further comprising a pressure transmitter operatively connected to the incoming hydraulic line and capable of sensing the magnitude of pressure in said line and transmitting a pressure signal to the analog input.

11. The drive system of claim 10, further comprising a pressure indicator operatively connected to the analog input to display an indication of the pressure measured by the pressure transmitter.

12. The drive system of claim 9, further comprising a manipulator arm coupled to the piston such that extension of the piston causes movement of the manipulator arm in a first direction and retraction of the piston causes movement of the manipulator arm in a second direction, opposite the first direction.

13. A manipulator drive system comprising:
a. a proportional mode controller configured to output a proportional mode control signal responsive to the position of the proportional mode controller;
b. a variable rate mode controller configured to output a variable rate mode control signal responsive to a preselected setting;
c. a local control computer operatively coupled to receive a selected input from one of the proportional mode controller or the variable rate mode controller;
d. a mode selector device operatively coupled to the local control computer to cause the local control computer to selectively receive at least one of the variable rate mode control signal and the proportional mode control signal and to selectively output one of the variable rate mode control signal and the proportional mode control signal as the selected mode control signal; and
e. a rate controller button operatively connected to the variable rate mode controller.

14. The drive system of claim 13, wherein the local control computer comprises an analog input receiver operatively coupled to receive the proportional mode control signal.

15. The drive system of claim 14, wherein the selected mode control signal is a digital signal.

16. The drive system of claim 13, wherein the variable rate mode control signal is an analog signal and the local control computer comprises an analog input receiver operatively coupled to receive the analog signal from the variable rate mode controller.

17. The drive system of claim 15, wherein the local control computer is configured to read, filter and scale the proportional mode signal.

18. The drive system of claim 16, further comprising a remote control computer operatively connected to the local control computer to receive the selected mode control signal, said remote control computer comprising:
a. at least one analog input channel; and
b. a pulse width modulated output unit, capable of generating a control signal.

19. The drive system of claim 18, further comprising:
a. proportional valve comprising a fluid inlet port and a fluid outlet port, said proportional valve being configured to receive a control signal from the pulse width modulation unit in the remote control computer;
b. a outgoing hydraulic line having a first end connected to the fluid outlet port and having a second end opposite the first end;
c. an incoming hydraulic line having a first end connected to the fluid inlet port and having a second end opposite the first end;
d. a piston housing comprising an inlet port connected to the second end of the outgoing hydraulic line and an outlet port connected to the second end of the incoming hydraulic line; and
e. a piston slideably mounted within the piston housing such that it can be selectively retracted or extended in response to the direction of hydraulic fluid flow in the outgoing and incoming hydraulic lines.

20. The drive system of claim 19, further comprising a pressure transmitter operatively connected to the incoming hydraulic line and capable of sensing the magnitude of pressure in said line and transmitting a pressure signal to the analog input.
